(19) United States
(12) Patent Application Publication
(10) Pub. No.: US 2016/0277329 A1
(43) Pub. Date: Sep. 22, 2016

(54) SYSTEM AND METHOD OF INTERACTING WITH CONTENT IN AN INSTANT MESSAGING BUBBLE

(71) Applicant: Beam Propulsion Lab Inc., Toronto (CA)

(72) Inventors: Alec Gordon, Toronto (CA); Paul (Po-Yao) Wang, Toronto (CA)

(21) Appl. No.: 15/073,504

(22) Filed: Mar. 17, 2016

Related U.S. Application Data
(60) Provisional application No. 62/134,834, filed on Mar. 18, 2015.

(51) Int. Cl. H04L 12/58; H04W 4/12

(52) U.S. Cl. CPC H04L 51/046; H04W 4/12

(57) ABSTRACT

A method is provided for relaying instant messages between a first user of a first mobile device and a second user of a second mobile device. After at least a first character of a first message input by the first user is received, the at least first character of the first message is sent to be displayed on the second mobile device of the second user substantially simultaneously as the at least first character is input by the first user. The at least first character is sent without the first user pressing a send button or otherwise expressly issuing a send command.

### CROSS-REFERENCE TO RELATED APPLICATIONS

This application claims the benefit of U.S. Provisional Patent Application No. 62/134,834, filed Mar. 18, 2015, which is incorporated herein by reference in its entirety.

### FIELD OF INVENTION

The invention relates to instant messaging and more particularly relates to methods of relaying and interacting with content in instant messaging bubbles.

### BACKGROUND

Online chat and instant messaging differ from other technologies such as email as they are near real-time communication methods. This has allowed instant messaging to become a great social networking tool. IM allows people to stay in touch with friends and family by using Internet chat conversations to relay information back and forth in near real-time. Instant messaging allows near real-time communication between two people in any part of the world without having to pay the international or domestic long distance charges associated with using phones to make calls or send SMS messages.

In Instant Messaging, short messages are typically transmitted bi-directionally between two parties. Each short message is transmitted to the other party when the sending party selects/presses “send”. A message is not sent until the party presses the “send” button explicitly. A draft message can thus sit unsent in a user's instant messaging app for a period of time. For example a user can simply forget to press the send button, and the instant message can simply sit there as a draft. In a fast moving world where instant messages are being sent while multi-tasking and juggling many other items, having to select/press an extra button can cause delays and communication problems between users.

When rapid exchange of information is required in IM, one party has to wait until the other responds. The “send and receive” message communication causes delay in the interaction and results in frustration. Additionally in some cases both parties may be typing at the same time and the conversation may go off on a tangent as a result. Such methods fall short of delivering real-time communications.

Additionally with this “send and receive” message communication, once a message is sent, a user has no control over the message. For example typos, inadvertent words or entire messages may be sent in haste or in jest. But, once sent, the user cannot retrieve the sent message or delete/edit any part of it.

### SUMMARY

Broadly speaking, the present invention provides a system and method that allows participants to interact with text/content in the same Chat or IM (Instant Messaging) bubble without actually sending a message.

As noted earlier, in Instant Messaging short messages are typically transmitted bi-directionally between two parties only when a user chooses to complete a thought and select/press the “send” button. The present invention provides a mechanism for sending and receiving instant messages without having to press/select the “send” button in the IM client.

The system and method provide a mechanism for more than one participant in a chat or IM session to interact with the text/content e.g. delete text, correct typographical errors, erase entire conversations, add or delete parts of graphics/images etc.

A first user can logs into the IM client. Users may need to sign up with an IM service provider.

Signing up to a system is well known in the art and may require a user to provide their credentials e.g. a user name and a password. The IM service provider then creates a unique user ID for the user. A unique user ID is provided to each user so that each user can be identified uniquely in the system so that the messages and other notification may be correctly routed to their devices as per their preferences.

In one embodiment, the first user selects a second user from a Buddy List, and initiates an IM session. A Buddy List or messenger list is a small active window inside an IM program that lists screen name contacts of other users who are contacts with whom a user can have an IM conversation.

The first user and second user may then start exchanging content in the same IM dialogue bubble. IM messages may be composed of text, emoticons, data files, pictures and videos. Users may use the touchscreen of the mobile device to compose text, and add emoticons or may use the keyboard on the mobile device to do the same.

The first user is preferably able to edit/modify/delete content entered by him in the IM dialogue bubble using the touchscreen of the mobile device or by using the keyboard of the mobile device.

The second user preferably sees the content change in real-time as it is edited/modified/deleted by first user on his IM client without sending the message. In one embodiment the second user is able to edit/modify/delete content entered by her (second user) in the IM dialogue bubble using the touchscreen of the mobile device or by using the keyboard of the mobile device.

In one embodiment, the first user sees the content change in real-time as it is edited/modified/deleted by the second user on his IM client without sending the message. Thus we note that the system and method of the current invention allows the two users to send and receive IM messages without the need to explicitly press/select the “send” button. Such IM messages may be composed of text, emoticons, data files, pictures and videos.

In one embodiment, the IM client embeds the logic for managing the synchronization of the state of content in the IM clients engaged in the IM/Chat session. Alternatively, this logic may be embedded in the server, or partially in the IM client and partially in the server.

Devices where the invention can be advantageously used include but are not limited to a personal computer (PC), which may include but not limited to a home PC, corporate PC, a Server, a laptop, a Netbook, tablet computers, a Mac, touch-screen computers running any number of different operating systems e.g. MS Windows, Apple iOS, Google Android, Linux, Ubuntu, etc. a cellular phone, a Smartphone, wearable technologies e.g. SmartWatches like iWatch, augmented reality headgear, a PDA, a tablet, an iPhone, an iPad, an iPod, an iPad, a PVR, a settop box, wireless enabled Blu-ray player, a TV, a SmartTV, wireless enabled connected devices, e-book readers e.g. Kindle or Kindle DX, Nook, etc. gaming consoles, and other such devices that may be capable of text, voice and video communications. Other embodiments may also use devices like Samsung's Smart Window, Google Glasses, Corning's new glass technologies, and other innovations and technologies that may be applicable to the invention at present or in the future.

Without limiting the solution to individual users or enterprise users, the solution aims to provide a mechanism allowing participants to interact with content in the same instant messaging bubble.

According to a first aspect of the invention, a method is provided for relaying instant messages of a first user of a first mobile device and a second user of a second mobile device. At least a first character of a first message input by the first user is received. The at least first character of the first message is then sent to be displayed on the second mobile device of the second user substantially simultaneously as the at least first character is input by the first user. The at least first character is sent without the first user pressing a send button or otherwise expressly issuing a send command. The at least first character may consist of a single character (i.e. messages are sent one character at a time, as each character is entered).

According to a second aspect of the invention, a method is provided for relaying instant messages between a first user of a first mobile device and a second user of a second mobile device. At least a first character of a first message input by the first user is received. The at least first character of the first message is sent to be displayed on the second mobile device of the second user. At least a first correction command making a change or correction to the at least first character of the first message from the first user is received. The at least first correction command is sent to modify the first message as shown on the second mobile device. The at least first character and the at least first correction command are sent without the first user pressing a send button or otherwise expressly issuing a send command.

Preferably, the at least first character and the at least first correction command are sent substantially simultaneously as they are input by the first user.

The at least first character may comprise a plurality of characters, in which case the first sending step may occur after one of the following:
a predetermined number of characters having been entered by the first user;
a predetermined time interval;
a predetermined time after a character was entered; or
a predetermined symbol or space in the first message (e.g. a space or a punctuation mark).

The at least first correction command may comprise a plurality of correction commands. In this case, the second sending step may occur after one of the following:
a predetermined number of correction commands having been entered by the first user;
a predetermined time interval;
a predetermined time after a correction command was entered; or
a predetermined symbol or space in the first message (e.g. a backspace or a carriage return).

At a predetermined time, a number of characters and correction commands that had been stored may be sent in a batch to synchronize the first message on the first mobile device with the first message on the second mobile device.

The first message may be displayed in a first bubble on the first mobile device and the second mobile device. If the correction commands have the effect of deleting all characters of the first message, the first bubble may disappear.

In addition to a text, numeric or symbol character, the at least first character may be an emoticon, a data file, an image file, or a video file (and strings and/or series of such characters or files).

The method may further include receiving at least a first character of a second message input by the second user and sending the at least first character of the second message to be displayed on the first mobile device of the first user. In this case, the second message may be displayed in a second bubble on the first mobile device and the second mobile device (or may be part of the same bubble as the first message). If sequential bubbles, the first message may continue in a third bubble if interrupted by the second message.

The method may further include receiving at least a first correction command making a change or correction to the at least first character of the second message from the second user and sending the at least first correction command to modify the second message as shown on the first mobile device.

If the correction commands have the effect of deleting all characters of the second message, the second bubble may disappear. In this case, the first and third bubble may be merged together.

If the correction command changes the first bubble, the contents of the first bubble may be brought down into the third bubble (so that the continuous message of the first user appears intact).

If the correction commands of both the first and second users have the effect of deleting their (respective) messages without (either user) pressing send or otherwise expressly issuing a send command, all bubbles may disappear (so that it is as though the conversation never happened).

In one embodiment, the characters and correction commands are exchanged through MQTT.

### BRIEF DESCRIPTION OF THE FIGURES

FIG. 1 is a flow diagram of a method of exchanging instant messages according to a preferred embodiment of the present invention.

FIG. 2 is a conceptual diagram of a message (containing errors) being simultaneously displayed on both a first mobile device and a second mobile device.

FIG. 3 is a flow diagram of deleting characters through the use of correction commands sent in real-time.

FIG. 4 is a flow diagram of a timer process.

FIG. 5 is a flow diagram of a synchronization process.

FIG. 6 is a conceptual diagram of a message with graphical elements displayed on a first mobile device and second mobile device.

FIG. 7 is a diagram showing editing graphical elements (following from FIG. 6).

### DETAILED DESCRIPTION

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements, as is common practice within the art. However, it will be appreciated that, in at least one embodiment, the components comprised in the method and tool may be actually implemented in software.

As will be appreciated, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks using which computer code may also be generated are Ruby on Rails which is based on the Ruby programming language, or node.js which is an event-driven server-side JavaScript environment.

In the preferred embodiment the program code may execute entirely on the server (or a cluster of servers), partly on a server and partly on a user's computer, as a stand-alone software package, partly on the user's computer and partly on a remote computer or entirely on the remote computer or server. In the latter scenario, the remote computer may be connected to the user's device e.g. a Smartphone through any type of network, including a local area network (LAN) or a wide area network (WAN), or the connection may be made to an external computer (for example, through the Internet using an Internet Service Provider).

A device that enables a user to engage with an application using the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the internet. The storage media can be inserted to the device where it is read. The device can then read program instructions stored on the storage media and present a user interface to the user. It should be noted that the terms computer, device, Smartphone etc. have been used interchangeably but imply any device that allows a user to install apps to send and receive instant messages.

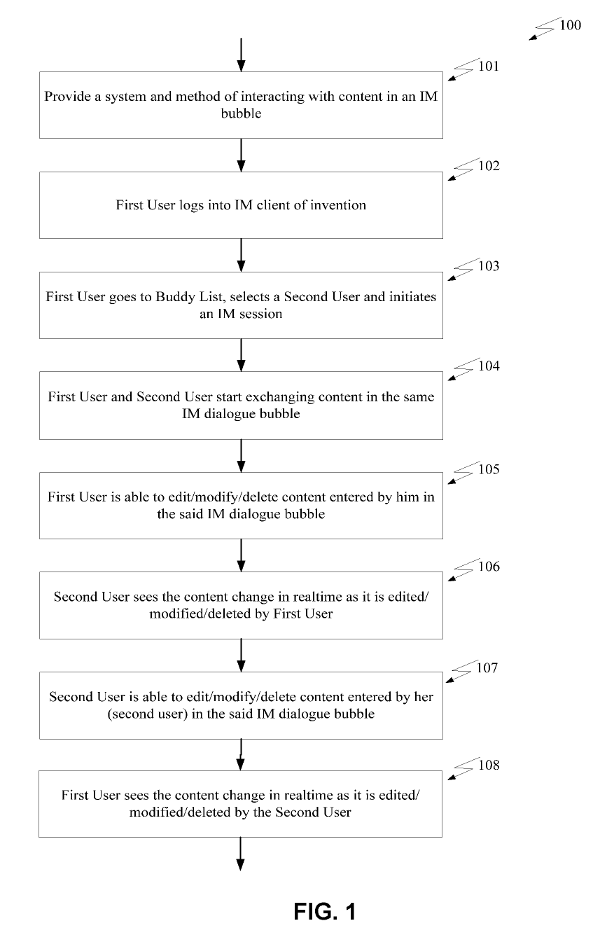

FIG. 1 shows the preferred embodiment of the method 100. A system and method is provided for interacting with content in an IM bubble 101. More than one participant may be enabled in an IM session to interact with the content in the same IM bubble.

Online chat and instant messaging differ from other technologies such as email as they are near real-time communications but each user must send his/her message and wait while the other user types the response and sends the message by explicitly pressing the send button.

Instant Messaging (IM) is a set of communication technologies used for text-based communication between two or more participants over the Internet or other types of networks. IM—chat happens in real-time. Instant messaging (IM) is a type of online chat which offers real-time text transmission over the Internet. Short messages are typically transmitted bi-directionally between two parties, when each user chooses to complete a thought and select “send”. Some IM applications can use push technology to provide real-time text, which transmits messages character by character, as they are composed. More advanced instant messaging can add file transfer, clickable hyperlinks, Voice over IP, or video chat. Instant messaging systems tend to facilitate connections between specified known users (often using a contact list also known as a “buddy list” or “friend list”). Depending on the IM protocol, the technical architecture can be peer-to-peer (direct point-to-point transmission) or client-server (a central server retransmits messages from the sender to the receiver). Each modern IM service generally provides its own client, either a separately installed piece of software, or a browser-based client. These usually only work with the IM client supplier company's service, although some IM clients allow limited functionality with other services.

IM as a service allows users to send typed messages, pictures, files, and live video with sound to a recipient based on their screen name. This exchange can go back and forth as long as both parties desire. IM provides a personal way of communicating with friends and other known contacts. In order to use this service a user must download a program and install it on their computer. Some popular services are Yahoo Messenger, Windows Live Messenger, and AIM (America Online IM).

As noted earlier, in Instant Messaging short messages are typically transmitted bi-directionally between two parties only when a user chooses to complete a thought and select/press the “send” button. The present invention provides a mechanism for sending and receiving instant messages without having to press/select the “send” button in the IM client.

Instant Messaging is a real-time messaging format. IM is a specialized form of ‘chat’ between people who know each other. Both IM users must be online at the same time for IM to fully work. IM is not as popular as email, but it is popular amongst teenagers and people in workplaces or offices that allow instant messaging.

A chat is a real-time online conversation between many computer users. It is like instant messaging, but with more than two people while most of the people are strangers to each other.

All participants must be in front of their computer at the same time. The chat takes place in a “chat room”, a virtual online room also called a channel. Users type their messages, and their messages appear on the monitor as text entries that scroll many screens deep. At a given time, two or more people can be in a chat room. They can freely send, receive and reply to messages from many chat users simultaneously. Non-IM types of chat include multicast transmission, usually referred to as “chat rooms”, where participants might be anonymous or might be previously known to each other (for example collaborators on a project that is using chat to facilitate communication).

In a chat, instead of one-to-one communication, users log on to a themed based virtual room and communicate with several people known only by their screen names. By sending typed messages to the room all connected users can read and respond like a big online get-together. There are numerous chat topics to choose from such as: hobbies, television shows, boy bands, sports, politics, health issues, and relationships.

A chat room window typically combines people who will only know each other based on their profile and registered screen name. If a person decides they want to “go private” with someone in the room, they can click that person's name and ask to send an Instant Message. At that point, both users are simultaneously participants in the chat room while engaging in a private IM session in a separate pop up window. Once a screen name is known, future Instant Messages can be sent to that person by simply opening the IM service, typing in the name and then typing a message.

In the present invention, a number of these conventions and formalities are dispensed with. To begin, the first user logs into the IM client 102. The users may need to sign up with an IM service provider implementing the present service. Signing up to an online service/system is well known in the art and may require a user to provide their credentials e.g. a user name and a password. The IM service provider then creates a unique user ID for the user. A unique user ID is provided to each user so that each user can be identified uniquely in the system so that the messages and other notification may be correctly routed to their devices as per their preferences.

There may be default settings and a user may opt to either accept these default settings or may opt to modify these setting for personalization to suit their needs e.g. a user may define their presence and availability preferences.

The first user goes to his/her Buddy List, selects a second user (recipient) and initiates an IM session 103.

A Buddy List or messenger list is a small active window inside an IM program that lists screen name contacts of other users who are contacts with whom a user can have an IM conversation. A Buddy List allows for quick communication between two users, whereby one clicks the name of the second and typing a message. A Buddy List may also indicate the “presence” of another user i.e. if that user is signed on to the service by placing some type of icon next to the name.

Presence refers to the ability to detect the electronic presence of other users who are connected to the Internet, through a PC or mobile device, and whether they are available in real-time. Presence information has wide applications in many communication services and is commonly used in applications like instant messaging clients, and discussion forums, VoIP clients etc. Presence is a status indicator that conveys ability and willingness of a potential communication partner. A user's client provides presence information (presence state) via a network connection to a presence service, which is stored in what constitutes the user's personal availability record and can be made available for distribution to other users to convey the availability of that user for communication.

Once selected and the messaging is initiated, the first user and second user can start exchanging content in the same IM dialogue bubble 104. IM messages may be composed of text, emoticons, data files, pictures and videos. Users may use the touchscreen of the mobile device to compose the text, and add emoticons or may use the keyboard on the mobile device to do the same.

The first user is preferably able to edit/modify/delete content entered by him in the IM dialogue bubble 105. The first user may edit/modify/delete using the touchscreen of the mobile device or by using the keyboard of the mobile device.

The second user preferably sees the content change in real-time as it is edited/modified/deleted by first user 106. In one embodiment second user sees the content change in real-time as it is edited/modified/deleted by first user on his IM client without sending the message.

The second user is able to edit/modify/delete content entered by her (second user) in the IM dialogue bubble 107. The second user may edit/modify/delete content entered by her (second user) in the IM dialogue bubble using the touchscreen of the mobile device or by using the keyboard of the mobile device.

The first user sees the content change in real-time as it is edited/modified/deleted by the second user 108.

Thus the two users can send and receive IM messages without having the need to explicitly press/select the “send” button.

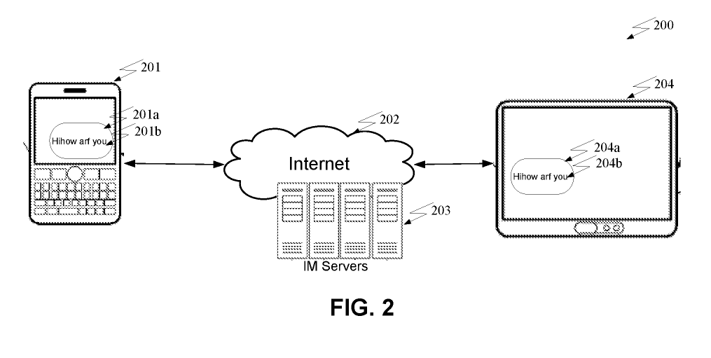

FIG. 2 shows one embodiment of the system 200 where two users are logged into the instant messaging service and are exchanging instant messages.

The first user is using a mobile device 201 e.g. a Smartphone, the IM service is being accessed over the Internet 202 where IM servers 203 are accessible; and the second user is using another mobile device 204 e.g. a tablet to engage in the IM conversation that is being facilitated by the IM servers 203.

The first user's device 201 has an instant messaging client (IM client) 201a installed on it while a second user's device 204 also has an IM client 204a installed on it.

For the first user, the text messages (IM conversation) that is in progress is depicted by 201a while the text characters entered by the first user are depicted by 201b on IM client running on first user's device 201.

Similarly for the second user, the text messages (IM conversation) that is in progress is depicted by 204a while the text characters entered by the first user are depicted by 204b on IM client running on second user's device 204.

FIG. 2 shows an IM session that is in progress and two participants, a first user and a second user are exchanging content in the same IM bubble without having to press/select the send button. Any content (text, words, sentences, emoticons, characters, graphics etc.) that is added/deleted/modified by either of the participants may be instantly updated in the same IM bubble without either party having to press/select the send button.

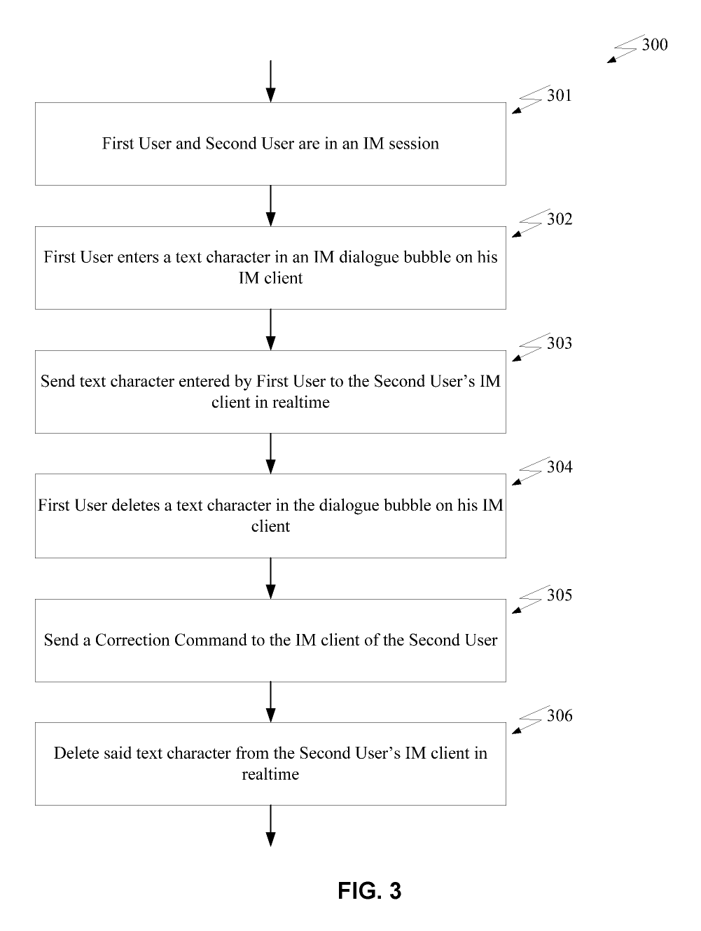

FIG. 3 shows one embodiment of the method 300 where a first user and a second user are in an IM session 301.

The first user enters a text character in an IM dialogue bubble on his IM client 302. The first user may use the touchscreen of the mobile device to enter a text character or content in the dialogue bubble on his IM client. There may be other means of entering text/content e.g. using a keyboard.

The text character entered by first user is preferably sent to the second user's IM client in real-time 303 over the network e.g. the Internet, cellular data network or LAN.

Words and sentences are composed of characters or letters. The IM client of the first user may send characters individually as they are entered, or in strings, or on a word by word or sentence by sentence basis to the IM client of the second user in real-time over the network. The IM client may be configured to wait for a word to be completed (entering a space indicates completion of a word) before sending it in real-time to the IM client of the other user; while the completion of a sentence (or phrase) may be signified by entering a period, a comma, a question mark, an exclamation mark or other such character that signifies the end of a sentence, phrase or multiple sentences (e.g. carriage return). In some embodiments this feature may be configurable either by the user or by the system.

The first user may deletes a text character in the dialogue bubble on his IM client 304. The first user may use the touchscreen of the mobile device to delete a text character or already added content in the dialogue bubble on his IM client. There may be other means of deleting text/content e.g. using a keyboard.

In this case, a Correction Command is sent to the IM client of the second user 305.

The correction command may cause the text character to be deleted from the second user's IM client in real-time 306.

The IM client may embed the logic for managing the synchronization of the state of content in the IM clients engaged in the IM/Chat session. Alternatively, the logic may be embedded in the server, or partially embedded in the IM client and partially embedded in the server.

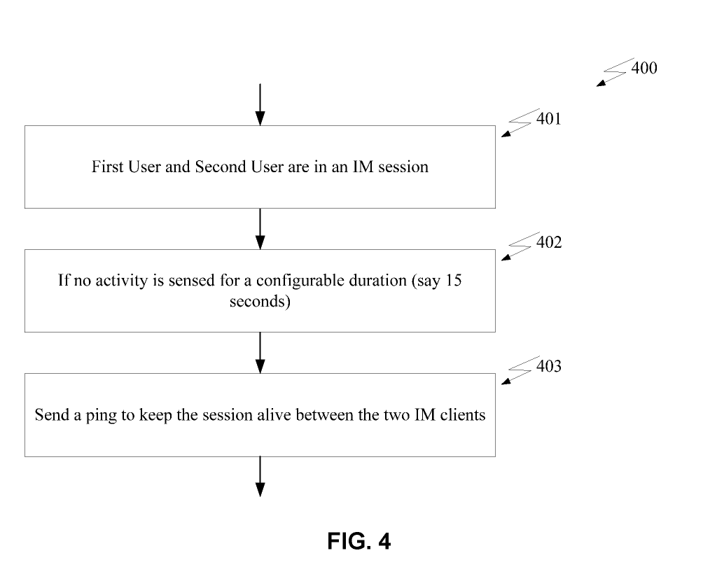

FIG. 4 shows one embodiment using a timer 400. A first user and a second user are in an IM session 401. The two users, a first user and a second user, may be engaged in an IM conversation using mobile devices; e.g. a first user is using a Smartphone while a second user is using a tablet.

If no activity is sensed for a configurable duration (e.g. 15 seconds) 402, an activity may be triggered (e.g. synchronization of the messages, including characters and correction commands that had been received). This timing may be driven by a timer/counter. After receiving any command or input/deletion of a text character the timer starts and as soon as another command or text input is sensed the timer is reset and starts the counter again. Only in a case where the counter reaches and exceeds the configurable upper limit of the counter (e.g. 15 seconds) it goes to the next step.

At the upper limit of the counter, one consequence may be to send a ping to keep the session alive between the two IM clients 403. Thus when there is no activity sensed and the timer reaches the configurable duration, in this case 15 seconds, the IM client can send a ping to the other IM client to keep the session alive.

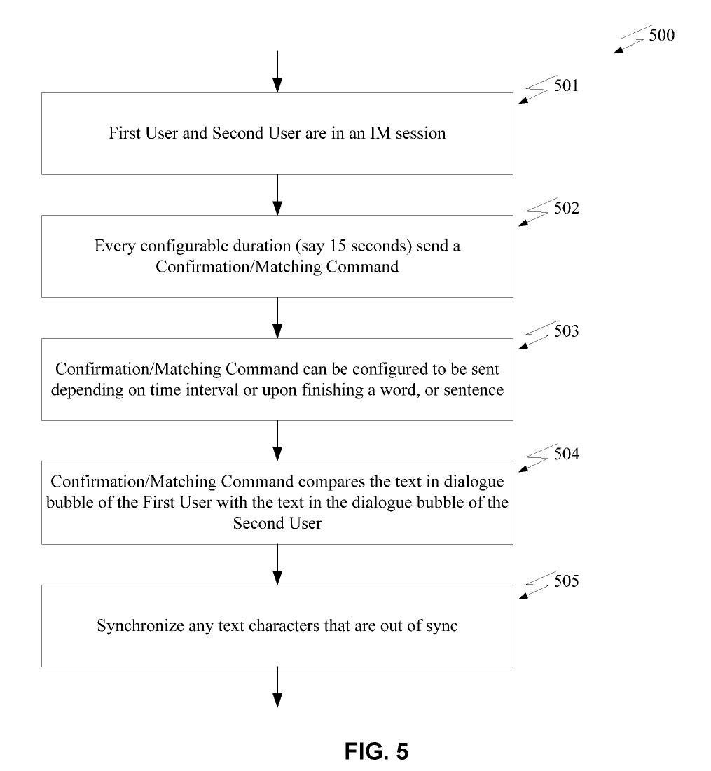

FIG. 5 shows one embodiment of the method 500. The first user and second user are in an IM session 501.

Every configurable duration (say 15 seconds) the system may send a Confirmation/Matching Command 502. The Confirmation/Matching Command may be sent over the network e.g. the internet, a cellular data network or the LAN.

The Confirmation/Matching Command can be configured to be sent depending on time interval or upon finishing a word, or sentence 503. In one embodiment the Confirmation/Matching Command may be configured to be sent from one IM client to another depending on time interval while in another embodiment the Confirmation/Matching Command is sent from an IM client upon the finishing a word, or a sentence being entered by a user.

The Confirmation/Matching Command can compare the text in dialogue bubble of the first user with the text in the dialogue bubble of the second user 504.

Any text characters that are out of sync may be synchronized 505. Thus if the second user is entering text, upon the second user's finishing to enter a word, a Confirmation/Matching Command is sent from the IM client of the second user to the IM client of the first user to compare the text in the respective IM bubbles and synchronize any text/content that is out of sync. This method of relaying messages in progress may, for example, avoid the need for multiple changes to the same word, which can simply be sent in its final form.

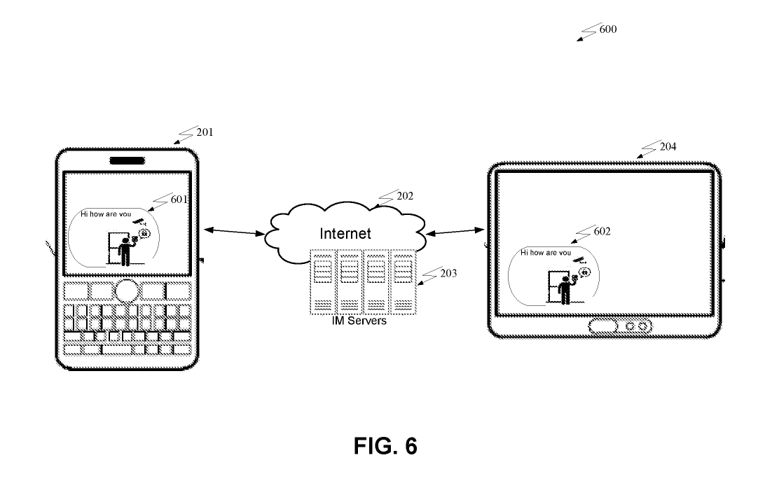

FIG. 6 shows one embodiment of the system 600. The first user adds an image/graphic to the IM Bubble. In one embodiment a first user may drag and drop an image/graphic or may take a picture using the camera in the mobile device or may choose to attach a file from locally stored data/content on the mobile device.

The image/graphic added by the first user may appear in the IM bubble of the second user in real-time. In one embodiment the drawing of a graphic may use the following:
Initiate Collaborative Drawing (Canva dimensions can varies from device to device)
When initiating the collaborative picture sharing option first user's IM client sends the size of the Canva and device's screen dimensions with an randomly generated ID
Second user's IM client receives the dimensions of the first user's size of the Canva and device's screen dimensions and create an Canva on the screen (keeping the same aspect ratio) and send back its own device's screen dimensions

### Real-Time Drawing/Erasing

first user's IM client sends the draw/erase commands, Canva ID, paint color/size, and the location coordinate of the drawing on the screen to second user's IM client
Second user's IM client receives and execute an algorithm to alter the paint color/size, and the location coordinate of the drawing on the screen to fit in second user's device screen and then display it.

### Error Checking

Track the list of history commands that occur on the device (draw/erase)
Periodically (e.g. every 1 second) sync up both devices so that the command list should be the same across both devices (hence same resulting picture as they executed the same commands)
In case there is a discrepancy (conflict) the list of commands for the first user would be considered the “correct” list (first user may be considered like a “host”).

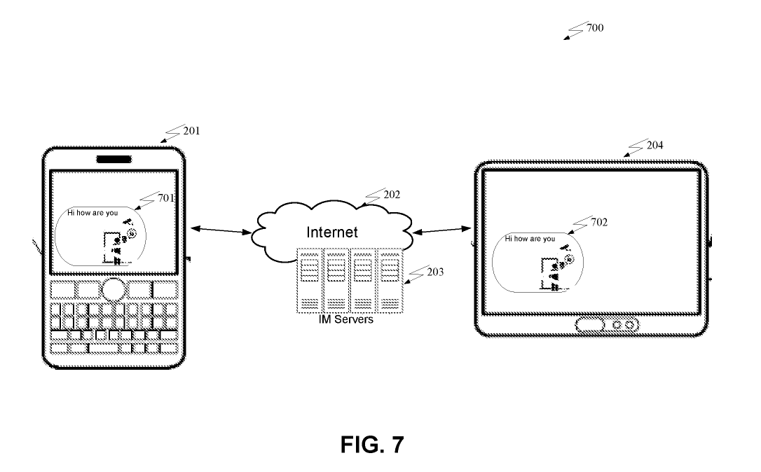

FIG. 7 shows one embodiment of the system continuing from FIG. 6 700. The first user starts to delete/erase the image/graphic that was added by him to the IM Bubble. In one embodiment a first user may start to erase the image/graphic to the IM Bubble by using the finger on a touchscreen to simulate an eraser to erase parts of the image/graphic, or erase/delete the entire image/graphic by pressing a button or by selecting another command dedicated for erasing/deleting content.

As shown in FIG. 7, the image/graphic added by the first user starts to disappear in the IM bubble of the second user in real-time exactly as the first user is erasing it in real-time.

In one embodiment the drawing of a graphic may use the following:

### Deletion

IM client of first user sends delete command with Canva ID to the IM client of the second user
IM client of second user receives the delete command with the Canva ID and deletes the corresponding Canva from its screen.

In one embodiment, the IM participant initiating the entering or adding of any content may retain control over the content that is being shared in the IM or Chat session and may erase/delete/modify/edit the content at will. In another embodiment, either participant in an IM session may erase/delete/modify/edit the content being shared in the IM or Chat session.

In one embodiment the interrupt mechanism in a real-time instant message conversation follows the logic given below:

Case 1. Beam In Condition

When the first user is typing (first cell) if the second user starts typing (in the second cell) the algorithm would detect that both parties are typing at the same time and continue first user's sentence (starting the following word) in the third cell. This effect would continue to occur as long as the sentence is not finished (a sentence is finished when first user presses the Send/Finish button).

Case 2. Delete Condition

Users engaged in an IM conversation are able to delete/modify everything on both ends (sender and receiver) they are typing until the Send/Finish button is pressed. Once deleted, there is no history or trace of whatever the users typed as if the IM conversation never happened.

Case 3. Delete Beam In

When users are engaged in an IM conversation as per Case 1 (Beam In), second user deletes everything he was typing in the second cell. The second cell would be removed and original third cell will merge with the first cell as if second user never interrupted the first user.

Case 4. Continuous Beam In
4.1) Continuous Beam In Condition

When Beam in Condition is met (three cells where first user occupies the first and third cell), if second user finishes the Beam In sentence in second cell and starts a new sentence it would be inserted into the fourth cell, and first user continues in the fifth cell
4.2) Delete
Following the scenario in 4.1
4.2.1 second user Deletes
second user deletes the fourth cell, the fifth cell would be merged with the third cell
4.2.2 first user Deletes
first user deletes the fifth and third cells, the Beam In cell (original fourth cell) would remain in the Beam In bubble.
4.2.3 first user Modifies
When first user modifies content in any cells other than the last one, all contents after the modified point (include the modified word) will be immediately brought down to the last cell. In the case where first user modifies the very first word, all content will be brought down, leaving Beam In cells on top.

The IM messages may be composed of text, emoticons, data files, pictures and videos.

The IM messages may be encrypted using protocols like SSL/TLS.

The preferred embodiment may use MQTT (formerly Message Queue Telemetry Transport) which is a machine-to-machine (M2M)/“Internet of Things” connectivity protocol. It was designed as an extremely lightweight publish/subscribe messaging transport and is useful for. connections with remote locations where a small code footprint is required and/or network bandwidth is at a premium.

Devices where the invention can be advantageously used may include but not limited to a personal computer (PC), which may include but not limited to a home PC, corporate PC, a Server, a laptop, a Netbook, tablet computers, a Mac, touch-screen computers running any number of different operating systems e.g. MS Windows, Apple iOS, Google Android, Linux, Ubuntu, etc. a cellular phone, a Smartphone, wearable technologies e.g. SmartWatches like iWatch, augmented reality headgear, a PDA, a tablet, an iPhone, an iPad, an iPod, an iPad, a PVR, a settop box, wireless enabled Blu-ray player, a TV, a SmartTV, wireless enabled connected devices, e-book readers e.g. Kindle or Kindle DX, Nook, etc. gaming consoles, and other such devices that may be capable of text, voice and video communications. Other embodiments may also use devices like Samsung's Smart Window, Google Glasses, Corning's new glass technologies, and other innovations and technologies that may be applicable to the invention at present or in the future.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable storage medium or other computer program product configured for execution by one or more processors.

It should be understood that although the term application has been used as an example in this disclosure the term may also apply to any other piece of software code where the embodiments are incorporated. The software application can be implemented in a standalone configuration or in combination with other software programs and is not limited to any particular operating system or programming paradigm described here.

Several exemplary embodiments/implementations have been included in this disclosure. The application is not limited to the cited examples.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of relaying instant messages of a first user of a first mobile device and a second user of a second mobile device, comprising:
receiving at least a first character of a first message input by the first user; and
sending the at least first character of the first message to be displayed on the second mobile device of the second user substantially simultaneously as the at least first character is input by the first user;
wherein the at least first character is sent without the first user pressing a send button or otherwise expressly issuing a send command.

2. The method of claim 1, wherein the at least first character consists of a single character.

3. A method of relaying instant messages between a first user of a first mobile device and a second user of a second mobile device, comprising:
receiving at least a first character of a first message input by the first user;
sending the at least first character of the first message to be displayed on the second mobile device of the second user;
receiving at least a first correction command making a change or correction to the at least first character of the first message from the first user; and
sending the at least first correction command to modify the first message as shown on the second mobile device;
wherein the at least first character and the at least first correction command are sent without the first user pressing a send button or otherwise expressly issuing a send command.

4. The method of claim 3, wherein the at least first character and the at least first correction command are sent substantially simultaneously as they are input by the first user.

5. The method of claim 3, wherein the at least first character comprises a plurality of characters, and the first sending step occurs after one of:
a predetermined number of characters having been entered by the first user;
a predetermined time interval;
a predetermined time after a character was entered; or
a predetermined symbol or space in the first message.

6. The method of claim 3, wherein the at least first correction command comprises a plurality of correction commands, and the second sending step occurs after one of:
a predetermined number of correction commands having been entered by the first user;
a predetermined time interval;
a predetermined time after a correction command was entered; or
a predetermined symbol or space in the first message.

7. The method of claim 3, wherein at a predetermined time, a number of characters and correction commands that had been stored are sent in a batch to synchronize the first message on the first mobile device with the first message on the second mobile device.

8. The method of claim 3, wherein the first message is displayed in a first bubble on the first mobile device and the second mobile device.

9. The method of claim 8, wherein if the correction commands have the effect of deleting all characters of the first message, the first bubble disappears.

10. The method of claim 3, wherein the at least first character is an emoticon, a data file, an image file, or a video file.

11. The method of claim 3, further comprising:
receiving at least a first character of a second message input by the second user; and
sending the at least first character of the second message to be displayed on the first mobile device of the first user.

12. The method of claim 11, wherein the second message is displayed in a second bubble on the first mobile device and the second mobile device.

13. The method of claim 12, wherein the first message continues in a third bubble if interrupted by the second message.

14. The method of claim 13, further comprising:
receiving at least a first correction command making a change or correction to the at least first character of the second message from the second user; and
sending the at least first correction command to modify the second message as shown on the first mobile device.

15. The method of claim 14, wherein if the correction commands have the effect of deleting all characters of the second message, the second bubble disappears.

16. The method of claim 15, wherein the first and third bubble are merged if the second bubble disappears.

17. The method of claim 14, wherein if the correction command changes the first bubble, the contents of the first bubble are brought down into the third bubble.

18. The method of claim 14, wherein if the correction commands of both the first and second users have the effect of deleting their messages without pressing send or otherwise expressly issuing a send command, all bubbles disappear.

19. The method of claim 3, wherein the characters and correction commands are exchanged through MQTT.
